(19) United States
(12) Patent Application Publication
(10) Pub. No.: US 2021/0329742 A1
(43) Pub. Date: Oct. 21, 2021

(54) CONTROL DEVICE AND CONTROL SYSTEM

(71) Applicant: KABUSHIKI KAISHA TOKAI RIKA DENKI SEISAKUSHO, Aichi (JP)

(72) Inventor: Yuichi KANO, Aichi (JP)

(73) Assignee: KABUSHIKI KAISHA TOKAI RIKA DENKI SEISAKUSHO, Aichi (JP)

(21) Appl. No.: 17/259,761

(22) PCT Filed: May 27, 2019
(86) PCT No.: PCT/JP2019/020852

§ 371 Date: Jan. 12, 2021

(30) Foreign Application Priority Data
Aug. 3, 2018 (JP) 2018-146600

(51) Int. Cl. H05B 3/02; H05B 1/02

(52) U.S. Cl. CPC H05B 3/02; H05B 2203/035; H05B 1/0225

(57) ABSTRACT

[Object] To provide a control device and control system that make it possible to suppress overheating of a heater element without providing the heater element with an overheat prevention device.

[Solution] Provided is the control device for controlling driving of the heater element that produces heat when electric power is supplied, the control device including: an electric power control circuit configured to control electric power to be supplied to the heater element; a breaker circuit configured to interrupt distribution of electric power to the heater element; and a processor configured to control operation of the electric power control circuit and operation of the breaker circuit. The processor determines whether malfunction is caused with regard to the driving of the heater element on the basis of a predetermined malfunction detection condition, and causes the breaker circuit to interrupt the distribution of the electric power in the case where it is determined that the malfunction is caused.

### TECHNICAL FIELD

The present invention relates to a control device and a control system.

### BACKGROUND ART

Technologies related to control over driving of a heater element have been developed. For example, a technology disclosed in Patent Literature 1 is “a technology of controlling current to be supplied to the electric heater on the basis of comparison between temperature of an electric heater (corresponding to a heater element) and set temperature”.

### CITATION LIST

### Patent Literature

Patent Literature 1: JP 2014-128079A

### DISCLOSURE OF INVENTION

### Technical Problem

For example, in the case of using the heater element such as a sheath heater or a positive temperature coefficient (PTC) heater that produce heat when electric power is supplied, sometimes the heater element is provided with an overheat prevention device such as a thermostat to prevent temperature of the heater element from exceeding specified temperature that has been set. In the case where the heater element is provided with the overheat prevention device, it is possible to protect the heater element in such a manner that temperature of the heater element does not exceed the specified temperature, and it is possible to suppress overheating of the heater element.

However, the overheat prevention device is relatively expensive. Therefore, cost increases in the case where the heater element is provided with the overheat prevention device.

An object of the present invention is to provide a novel and improved control device and control system that make it possible to suppress overheating of the heater element without providing the heater element with the overheat prevention device.

### Solution to Problem

To achieve the above-described purpose, according to an aspect of the present invention, there is provided a control device for controlling driving of a heater element that produces heat when electric power is supplied, the control device including: an electric power control circuit configured to control electric power to be supplied to the heater element; a breaker circuit configured to interrupt distribution of electric power to the heater element; and a processor configured to control operation of the electric power control circuit and operation of the breaker circuit. The processor determines whether malfunction is caused with regard to the driving of the heater element on the basis of a predetermined malfunction detection condition, and causes the breaker circuit to interrupt the distribution of the electric power in the case where it is determined that the malfunction is caused.

Such a configuration allows the processor to determine that malfunction is caused with regard to driving of the heater element, and the breaker circuit interrupts distribution of electric power to the heater element. Therefore, such a configuration makes it possible to suppress overheating of the heater element without providing the heater element with the overheat prevention device.

In addition, when the electric power control circuit is in a non-operating state, the processor may determine that the malfunction is caused in the case of detecting operation of the electric power control circuit to supply electric power to the heater element.

In addition, when the electric power control circuit is in an operating state, the processor may determine that the malfunction is caused in the case of detecting abnormal overheating of the heater element.

In addition, the processor may determine that the malfunction is caused in the case where an estimation value of temperature of the heater element is larger than a first abnormality determination threshold when supply of electric power from the electric power control circuit to the heater element is detected while the electric power control circuit is in the operating state, or in the case where the estimation value is the first abnormality determination threshold or more when the supply of electric power from the electric power control circuit to the heater element is detected while the electric power control circuit is in the operating state.

In addition, the processor may put the electric power control circuit into a non-operating state in the case where it is determined that the malfunction is caused, and the processor may cause the breaker circuit to cancel the interruption of the distribution of the electric power when the electric power control circuit is shifted from the non-operating state to an operating state after the breaker circuit interrupts the distribution of the electric power.

In addition, the heater element may include a temperature detection element for detecting temperature, and the processor may determine that the malfunction is caused in the case where abnormality in the temperature detection element is detected on the basis of ambient temperature of the heater element and detection temperature detected via the temperature detection element.

In addition, the processor may determine that the malfunction is caused in the case where the detection temperature is lower than a second abnormality determination threshold corresponding to the ambient temperature when a predetermined period of time elapses after the electric power control circuit is shifted from the operating state to the non-operating state, or in the case where the detection temperature is the second abnormality determination threshold or less when the predetermined period of time elapses.

In addition, the processor may cause the breaker circuit to cancel the interruption of the distribution of the electric power when abnormality in the temperature detection element is not detected after causing the breaker circuit to interrupt the distribution of the electric power.

To achieve the above-described purpose, according to another aspect of the present invention, there is provided a control system including: a heater element configured to produces heat when electric power is supplied; and a control device configured to control driving of the heater element. The control device includes an electric power control circuit configured to control electric power to be supplied to the heater element, a breaker circuit configured to interrupt distribution of electric power to the heater element, and a processor configured to control operation of the electric power control circuit and operation of the breaker circuit. The processor determines whether malfunction is caused with regard to the driving of the heater element on the basis of a predetermined malfunction detection condition, and causes the breaker circuit to interrupt the distribution of the electric power in the case where it is determined that the malfunction is caused.

Such a control system allows the control device to determine that malfunction is caused with regard to driving of the heater element, and interrupt distribution of electric power to the heater element. Therefore, such a control system makes it possible to suppress overheating of the heater element without providing the heater element with the overheat prevention device.

### Advantageous Effects of Invention

According to the present invention, it is possible to suppress overheating of the heater element without providing the heater element with the overheat prevention device.

### BRIEF DESCRIPTION OF DRAWINGS

FIG. 1 is a block diagram illustrating an example of a configuration of a control system according to an embodiment of the present invention.

FIG. 2 is an explanatory diagram for describing an example in which a control device according to the embodiment of the present invention determines that an electric power control circuit malfunctions.

FIG. 3 is an explanatory diagram for describing another example in which the control device according to the embodiment of the present invention determines that the electric power control circuit malfunctions.

FIG. 4 is an explanatory diagram for describing an example in which the control device according to the embodiment of the present invention determines that a heater element malfunctions.

FIG. 5 is an explanatory diagram for describing another example in which the control device according to the embodiment of the present invention determines that a heater element malfunctions.

FIG. 6 is an explanatory diagram for describing an example in which the control device according to the embodiment of the present invention determines that a temperature detection element malfunctions.

FIG. 7 is an explanatory diagram for describing another example in which the control device according to the embodiment of the present invention determines that the temperature detection element malfunctions.

### MODE(S) FOR CARRYING OUT THE INVENTION

Hereinafter, preferred embodiments of the present invention will be described in detail with reference to the appended drawings. Note that, in this specification and the appended drawings, structural elements that have substantially the same function and structure are denoted with the same reference signs, and repeated explanation of these structural elements will be omitted.

[1] Overview of Control System According to Embodiment of Present Invention

A control system according to an embodiment of the present invention (hereinafter, sometimes simply referred to as “control system”) is a system including a heater element and a control device that controls driving of the heater element.

Note that, the configuration of the control system is not limited thereto. For example, the control system may include another structural element such as a temperature detection element (to be described later). In addition, the control system may include various kinds of hardware depending on application examples of the control system (to be described later).

[1-1] Heater Element

The heater element is a device (which is element or circuit) that produces heat when electric power is supplied. Examples of the heater element include any heater that produces heat when electric power is supplied such as a sheath heater or a PTC heater.

[1-2] Control Device

The control device is a device that controls driving of the heater element.

For example, the control device includes an electric power control circuit, a breaker circuit, and a processor.

Note that, the configuration of the control device is not limited thereto. For example, the control device may include a storage medium that stores various kinds of data such as “data to be used for determining malfunction like data representing an overcurrent determination value (to be described later)”. In addition, for example, the control device may further include a circuit related to detection of malfunction in driving of the heater element such as an output state detection circuit and a temperature detection circuit (to be described later). In addition, the control device may include various kinds of hardware depending on application examples of the control device (to be described later).

[1-2-1] Electric Power Control Circuit and Breaker Circuit

The electric power control circuit is a circuit (or a circuit family. The same applies hereinafter) having a function of controlling electric power to be supplied to the heater element. Examples of the electric power control circuit include an intelligent power device (IPD).

The breaker circuit is a circuit (or a circuit family. The same applies hereinafter) having a function of interrupting distribution of electric power to the heater element. Examples of the breaker circuit include a transistor. Examples of the transistor that functions as the breaker circuit include “a field-effect transistor such as an N-channel metal-oxide-semiconductor field-effect transistor (MOSFET), a P-channel MOSFET, or a junction field-effect transistor (JFET)”, and “a bipolar transistor such as an insulated-gate bipolar transistor (IGBT)”.

In an ON state, the transistor that functions as the breaker circuit does not interrupt distribution of electric power to the heater element. In an OFF state, the transistor interrupts distribution of electric power to the heater element.

Each of the electric power control circuit and the breaker circuit is interposed between a power source and the heater element or between the heater element and a reference potential point (hereinafter, sometimes referred to as “GND”), and the electric power control circuit and the breaker circuit are electrically connected to the heater element. Examples of the power source include an internal power source such as a battery of the control system (for example, a battery of the control device) and an external power source of the control system such as a commercial power source. Hereinafter, sometimes a circuit connected to a power source side may be referred to as a “high-side driving part” among circuits that are electrically connected to the heater element. In addition, hereinafter, sometimes a circuit connected to a reference potential point side may be referred to as a “low-side driving part” among the circuits that are electrically connected to the heater element.

In the control device, the electric power control circuit and the breaker circuit are connected to the heater element in ways described in (a) to (c) listed below, for example.

(a) The electric power control circuit serves as the high-side driving part, and the breaker circuit serves as the low-side driving part.
(b) The electric power control circuit and the breaker circuit serve as the high-side driving part, but no circuit serves as the low-side driving part.
(c) No circuit serves as the high-side driving part, but the electric power control circuit and the breaker circuit serve as the low-side driving part.

[1-2-2] Processor

The processor is a circuit (or a circuit family. The same applies hereinafter) having a function of controlling operation of the electric power control circuit and operation of the breaker circuit. Examples of the processor include a microcontroller.

In addition, the processor determines that malfunction is caused with regard to the driving of the heater element on the basis of a predetermined malfunction detection condition. In the case where it is detected that a malfunction detection condition is satisfied, it is determined that the malfunction corresponding to the satisfied malfunction detection condition is caused. Examples of the malfunction related to driving of the heater element according to the embodiment of the present invention include malfunctions listed below.
Malfunction in the electric power control circuit
Abnormal overheating of the heater element
Abnormality in characteristics of the temperature detection element (to be described later) for detecting temperature of the heater element
Combination thereof

In the case where it is determined that at least one of the above-described malfunctions is caused, the processor causes the breaker circuit to interrupt distribution of electric power by controlling operation of the breaker circuit. Note that, in the case where it is determined that the malfunction is caused, the processor may stop supply of electric power to the heater element by controlling operation of the electric power control circuit. An example of the determination of the malfunction related to driving of the heater element will be described later.

An example of control over operation of the electric power control circuit will be described. For example, the processor controls operation of the electric power control circuit by transmitting a first control signal to the electric power control circuit. The first control signal is a signal for controlling whether or not to operate the electric power control circuit. Examples of the first control signal include a signal representing whether or not to operate the electric power control circuit by using signal levels (high level/low level).

Specifically, the processor transmits the first control signal for operating the electric power control circuit to the electric power control circuit in the case where a trigger for activating the heater is detected, such as the case where operation of activating the heater is detected, for example. In addition, the processor transmits the first control signal for preventing the electric power control circuit from operating to the electric power control circuit in the case where a trigger for stopping the heater is detected, such as the case where operation of stopping the heater is detected. Examples of the operation of activating the heater and operation of preventing the heater from activating include any operation such as operation performed on an operation device such as buttons, operation performed by voice, operation performed by gesture, and operation performed by a line of sight.

In addition, in the case where it is determined that the malfunction is caused, the processor may transmit the first control signal for preventing the electric power control circuit from operating to the electric power control circuit.

Note that, the first control signal is not limited to the above-described examples. The first control signal may be any signal capable of controlling whether or not to operate the electric power control circuit.

An example of control over operation of the breaker circuit will be described. For example, the processor controls operation of the breaker circuit by transmitting a second control signal to the breaker circuit. The second control signal is a signal for controlling whether or not to cause the breaker circuit to interrupt distribution of electric power (second control signal for controlling whether or not to operate the breaker circuit). Examples of the second control signal include “a signal for controlling the ON state/OFF state of the transistor included in the breaker circuit”.

In the case where the breaker circuit is the N-channel MOSFET, the processor does not cause the breaker circuit to interrupt distribution of electric power by applying a signal of a signal level for putting the MOSFET into the ON state to a control terminal of the MOSFET as the second control signal. In addition, in the case where the breaker circuit is the N-channel MOSFET, the processor causes the breaker circuit to interrupt distribution of electric power by applying a signal of a signal level for putting the MOSFET into the OFF state to the control terminal of the MOSFET as the second control signal. Note that, “in the case of causing the breaker circuit to interrupt distribution of electric power when the breaker circuit is the N-channel MOSFET”, the processor may stop applying the signal to the control terminal of the MOSFET.

Note that, the second control signal is not limited to the above-described examples. The second control signal may be any signal capable of controlling whether or not to operate the breaker circuit.

[1-3] Summary of Control System

As described above, in the control system, the control device determines whether malfunction is caused with regard to driving of the heater element. In addition, in the case where it is determined that the malfunction is caused, the control device causes the breaker circuit to interrupt the distribution of the electric power to the heater element. Because “the control device selectively interrupts distribution of electric power to the heater element in accordance with a result of determining whether malfunction is caused with regard to driving of the heater element”, it is possible to protect the heater element in such a manner that temperature of the heater element does not exceed specified temperature even in the case where the heater element is not provided with the overheat prevention device.

Therefore, the control system makes it possible to “suppress overheating of the heater element without providing the heater element with the overheat prevention device” because the control system includes the control device that controls driving of the heater element as described above.

[2] Example of Operation of Control System According to Embodiment of Present Invention

Next, an example of a configuration of the control system and an example of operation of the control system will be described.

Hereinafter, a case where the electric power control circuit is the high-side driving part and the breaker circuit is the low-side driving part in the control device will be described as an example. Note that, as described above, the relation of connection between the electric power control circuit, the breaker circuit, and the heater element is not limited to examples to be described below.

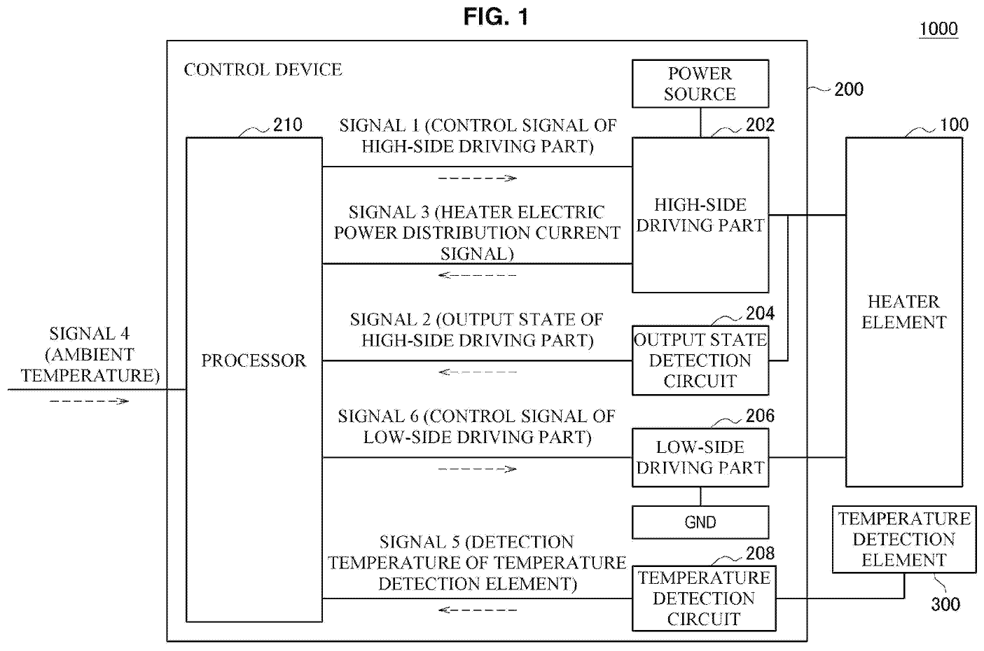

FIG. 1 is a block diagram illustrating an example of a configuration of a control system 1000 according to an embodiment of the present invention. For example, the control system 1000 includes a heater element 100, a control device 200, and a temperature detection element 300.

[2-1] Heater Element 100 and Temperature Detection Element 300

As described above, the heater element 100 is a device (which is element or circuit) that produces heat when electric power is supplied.

The temperature detection element 300 is an element (or circuit) for detecting temperature, and is disposed at a position capable of detecting temperature of the heater element 100. Examples of the temperature detection element 300 include any thermistors such as a negative temperature coefficient (NTC) thermistors, a positive temperature coefficient (PTC) thermistors, and a critical temperature resistor (CTR) thermistor. Note that, the temperature detection element 300 is not limited to the thermistors, and may be any element (or circuit) capable of detecting temperature.

Note that, the control system according to the embodiment of the present invention may be configured in such a manner that the control system does not include the temperature detection element 300. Even if the control system does not include the temperature detection element 300, the control device 200 is capable of controlling overheating of the heater element 100 by determining whether malfunction is caused with regard to driving of the heater element 100 through malfunction determination according to a first example (to be described later) or malfunction determination according to a second example (to be described later).

[2-2] Control Device 200

As described above, the control device 200 is a device that controls driving of the heater element 100.

For example, the control device 200 includes a high-side driving part 202, an output state detection circuit 204, a low-side driving part 206, a temperature detection circuit 208, and a processor 210.

The high-side driving part 202 is the electric power control circuit (corresponding to the above-described configuration (a)). Note that, as described above, the high-side driving part 202 may be the electric power control circuit and the breaker circuit (corresponding to the above-described configuration (b)). In addition, as described above, the control device 200 does not have to include the high-side driving part 202 (corresponding to the above-described configuration (c)).

The high-side driving part 202 is electrically connected to the processor 210. In the case where the high-side driving part 202 is the electric power control circuit, the processor 210 transmits the first control signal (“signal 1” illustrated in FIG. 1) to the high-side driving part 202. In addition, in the case where the high-side driving part 202 is the electric power control circuit, the high-side driving part 202 transmits a signal indicating electric power supplied to the heater element 100 (“signal 3” illustrated in FIG. 1) to the processor 210. Examples of the signal indicating electric power supplied to the heater element 100 include a heater electric power distribution current signal indicating a current value supplied to the heater element 100.

The output state detection circuit 204 is electrically connected to the high-side driving part 202 and the heater element 100, and detects operation of supplying electric power from the electric power control circuit to the heater element 100. Examples of the output state detection circuit 204 include a voltage detection circuit and a current detection circuit.

The output state detection circuit 204 is electrically connected to the processor 210, and transmits a signal indicating a result of detecting the operation of supplying electric power (“signal 2” illustrated in FIG. 1) to the processor 210. Examples of the signal indicating a result of detecting the operation of supplying electric power include “a signal indicating whether or not the high-side driving part 202 outputs electric power to the heater element 100 by using a signal level.

The low-side driving part 206 is the breaker circuit (corresponding to the above-described configuration (a)). Note that, as described above, the low-side driving part 206 may be the electric power control circuit and the breaker circuit (corresponding to the above-described configuration (c)). In addition, as described above, the control device 200 does not have to include the low-side driving part 206 (corresponding to the above-described configuration (b)).

The low-side driving part 206 is electrically connected to the processor 210. In the case where the low-side driving part 206 is the breaker circuit, the processor 210 transmits the second control signal (“signal 6” illustrated in FIG. 1) to the low-side driving part 206.

The temperature detection circuit 208 is electrically connected to the temperature detection element 300, and detects temperature of the heater element 100 via the temperature detection element 300. For example, in the case where the temperature detection element 300 is the thermistor, a resistance value of the thermistor varies depending on change in the temperature. In this case, the temperature detection circuit 208 detects the temperature of the heater element 100 by detecting voltage corresponding to change in temperature. The configuration of the temperature detection circuit 208 is not specifically limited. Hereinafter, sometimes the temperature of the heater element 100 detected by the temperature detection circuit 208 via the temperature detection element 300 is referred to as “detection temperature”.

The temperature detection circuit 208 is electrically connected to the processor 210, and transmits a signal indicating the detection temperature (“signal 5” illustrated in FIG. 1) to the processor 210. Examples of the signal indicating the detection temperature include a signal representing the detection temperature by using a numerical value.

The processor 210 controls operation of the electric power control circuit by transmitting the first control signal (“signal 1” illustrated in FIG. 1) to the high-side driving part 202, and controls operation of the breaker circuit by transmitting the second control signal (“signal 6” illustrated in FIG. 1) to the low-side driving part 206.

As illustrated in FIG. 1, the output state detection circuit 204 transmits the signal 2 to the processor 210, the high-side driving part 202 transmits the signal 2 to the processor 210, and the temperature detection circuit 208 transmits the signal 5 to the processor 210. In addition, as illustrated in FIG. 1, an external device of the control device 200 transmits a signal 4 to the processor 210. The “signal 4” is a signal indicating ambient temperature of the heater element 100 (to be described later). Examples of the signal indicating the ambient temperature include a signal representing the ambient temperature by using a numerical value.

In addition, as described in examples (1) to (4) listed below, the processor 210 determines that malfunction is caused with regard to the driving of the heater element 100 on the basis of a predetermined malfunction detection condition. For example, the processor 210 performs a process related to the determination at set intervals. The set interval may be a fixed period of time that has been set in advance, or may be a variable period of time that can be changed by operation performed by a user of the control system 1000 or the like.

In addition, the processor 210 causes the breaker circuit to interrupt distribution of electric power by transmitting the second control signal in the case where it is determined that the malfunction is caused.

(1) First Example of Malfunction Determination: Malfunction in Electric Power Control Circuit

The processor 210 determines that the malfunction in the electric power control circuit is caused “in the case where the electric power control circuit is in a non-operating state and operation of the electric power control circuit to supply electric power to the heater element 100 is detected” (example in which malfunction detection condition is satisfied).

Here, “the case where the electric power control circuit is in the non-operating state and operation of the electric power control circuit to supply electric power to the heater element 100 is detected” corresponds to “a case where the electric power control circuit supplies electric power to the heater element 100 although the processor 210 is stopping operation of the electric power control circuit”. In this case, there is a high possibility that malfunction in the electric power control circuit is caused because the supply of electric power is continuously in the ON state (so-called ON abnormality).

In the case where the ON abnormality is caused with regard to the electric power control circuit, electric power is continuously supplied to the heater element 100. Therefore, this increases a possibility that temperature of the heater element 100 exceed the specified temperature, that is, a possibility that abnormal overheating of the heater element 100 is caused.

Accordingly, “in the case where the electric power control circuit is in the non-operating state and operation of the electric power control circuit to supply electric power to the heater element 100 is detected”, the processor 210 determines that the malfunction is caused and causes the breaker circuit to interrupt distribution of electric power. There is no possibility that the abnormal overheating of the heater element 100 is caused by causing the breaker circuit to interrupt distribution of electric power even in the case where the ON abnormality is caused with regard to the electric power control circuit.

Therefore, the control system 1000 makes it possible to “suppress overheating of the heater element 100 without providing the heater element 100 with the overheat prevention device”.

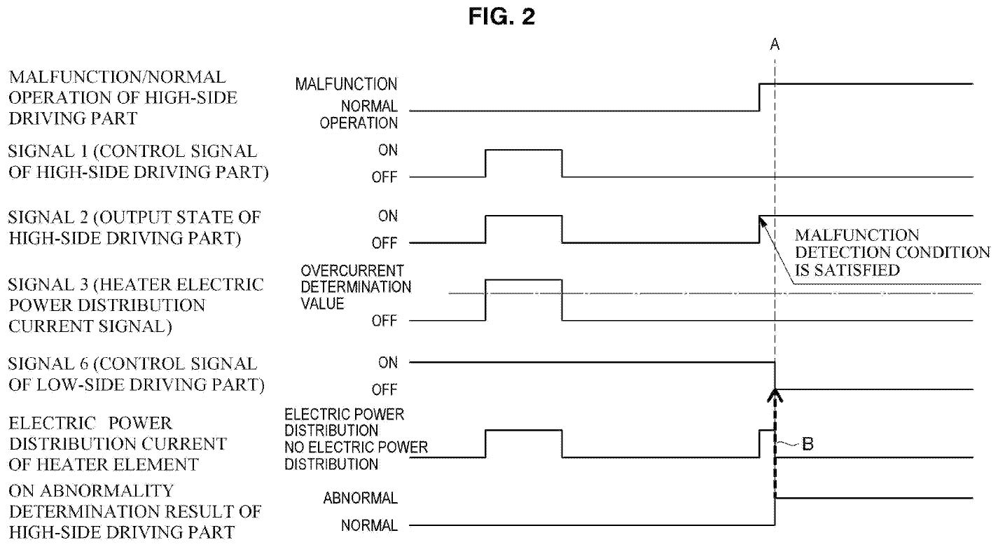

FIG. 2 is an explanatory diagram for describing an example in which the control device 100 according to the embodiment of the present invention determines that the electric power control circuit malfunctions.

Here, the “signal 1 indicating OFF” corresponds to the first control signal for putting the electric power control circuit into the non-operating state. In addition, the “signal 1 indicating ON” corresponds to the first control signal for putting the electric power control circuit into the operating state. The “signal 2 indicating OFF” means that operation of the electric power control circuit to supply electric power to the heater element 100 is not detected. The “signal 2 indicating ON” means that operation of the electric power control circuit to supply electric power to the heater element 100 is detected. The “signal 3 indicating OFF” means that a current value of electric power supplied from the electric power control circuit to the heater element 100 is 0 (zero). The “signal 6 indicating OFF” corresponds to the second control signal for causing the breaker circuit to interrupt distribution of electric power. In addition, the “signal 6 indicating ON” corresponds to the second control signal for preventing the breaker circuit from interrupting distribution of electric power. The same applies hereinafter with regard to the other drawings.

For example, as indicated by A in FIG. 2, the processor 210 determines that malfunction in the electric power control circuit is caused “in the case where the signal 2 indicating ON is detected while the signal 1 indicating OFF (first control signal) is being transmitted to the electric power control circuit”. “The case where the signal 2 indicating ON is detected while the signal 1 indicating OFF is being transmitted to the electric power control circuit” corresponds to an example in which “the electric power control circuit is in the non-operating state and operation of the electric power control circuit to supply electric power to the heater element 100 is detected”.

Next, as indicated by B in FIG. 2, the processor 210 causes the breaker circuit to interrupt distribution of electric power by transmitting the signal 6 indicating OFF (second control signal) to the low-side driving part 206.

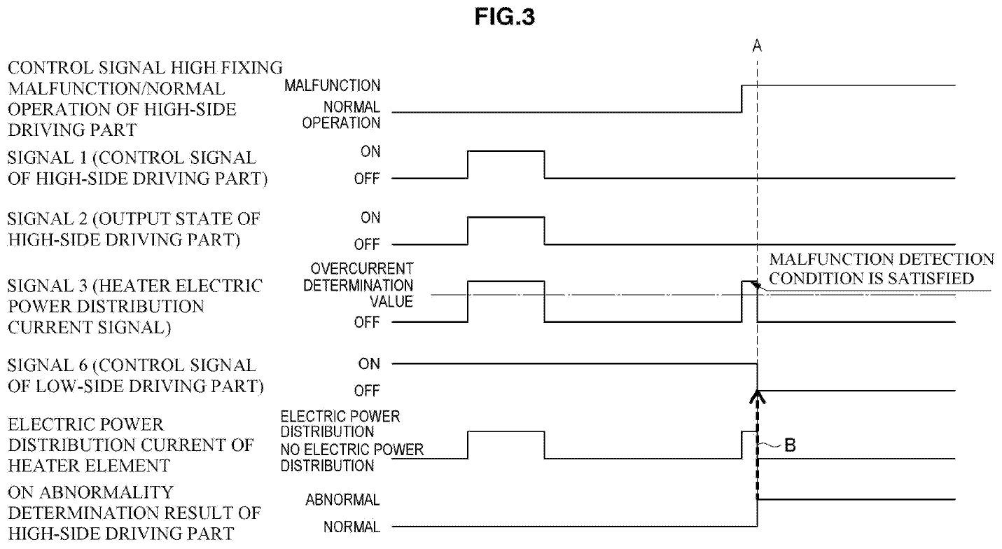

FIG. 3 is an explanatory diagram for describing another example in which the control device 200 according to the embodiment of the present invention determines that the electric power control circuit malfunctions.

For example, as indicated by A in FIG. 3, the processor 210 determines that malfunction in the electric power control circuit is caused “in the case where a current value indicated by the signal 3 is higher than the overcurrent determination value while the signal 1 indicating OFF (first control signal) is being transmitted to the electric power control circuit” (or “in the case where a current value indicated by the signal 3 is the overcurrent determination value or higher while the signal 1 indicating OFF is being transmitted to the electric power control circuit”. The same applies hereinafter). For example, the overcurrent determination value may be a fixed value that has been set in advance, or may be a variable value that can be changed by operation performed by the user of the control system 1000 or the like. “The case where the current value indicated by the signal 3 is larger than the overcurrent determination value while the signal 1 indicating OFF is being transmitted to the electric power control circuit” corresponds to another example in which “the electric power control circuit is in the non-operating state but operation of the electric power control circuit to supply electric power to the heater element 100 is detected”.

Next, as indicated by B in FIG. 3, the processor 210 causes the breaker circuit to interrupt distribution of electric power by transmitting the signal 6 indicating OFF (second control signal) to the low-side driving part 206.

For example, as indicated by A in FIG. 2 and A in FIG. 3, the processor 210 determines that the electric power control circuit malfunctions and causes the breaker circuit to interrupt distribution of electric power.

Note that, the process performed in the case where it is determined that the electric power control circuit malfunctions is not limited to the above-described examples. For example, it is also possible for the processor 210 to cause the breaker circuit to automatically cancel the interruption of the distribution of electric power after causing the breaker circuit to interrupt the distribution of electric power. Here, the case where the breaker circuit automatically cancels interruption of distribution of electric power corresponds to a case where “the heater element 100 automatically returns from a state where the heater element 100 is protected from overheating to a state where the heater element 100 is driven.

For example, the processor 210 maintains the state where the electric power control circuit is in the non-operating state, by continuously transmitting the signal 1 indicating OFF (first control signal) to the electric power control circuit. In addition, the processor 210 causes the breaker circuit to cancel the interruption of the distribution of the electric power “when the electric power control circuit is shifted from the non-operating state to the operating state after the breaker circuit interrupts the distribution of the electric power”.

Examples of a timing at which the electric power control circuit is shifted from the non-operating state to the operating state include a timing at which a trigger for activating the heater is detected in a state where the heater element 100 is protected from overheating such as a timing at which operation of activating the heater is detected. The processor 210 causes the breaker circuit to cancel interruption of distribution of electric power by transmitting the signal 6 indicating ON (second control signal) to the low-side driving part 206.

After the breaker circuit automatically cancels interruption of distribution of electric power, the processor 210 again determines whether malfunction is caused in accordance with the first example, and causes the breaker circuit to interrupt distribution of electric power in accordance with a result of the determination. Therefore, the control system 1000 makes it possible to “suppress overheating of the heater element 100 without providing the heater element 100 with the overheat prevention device” even in the case where the breaker circuit automatically cancel interruption of distribution of electric power.

(2) Second Example of Malfunction Determination: Abnormal Overheating of Heater Element 100

The processor 210 determines that the heater element 100 malfunctions “in the case where the electric power control circuit is in the operating state and abnormal overheating of the heater element 100 is detected”.

Here, “in the case where the electric power control circuit is in the operating state and abnormal overheating of the heater element 100 is detected”, there is a high possibility that short-circuit malfunction is caused with regard to the heater element 100.

In the case where the short-circuit malfunction is caused with regard to the heater element 100, it is possible to increase a possibility that the heater element 100 is abnormally overheated more when the electric power control circuit supplies electric power to the heater element 100.

Accordingly, “in the case where the electric power control circuit is in the operating state and abnormal overheating of the heater element 100 is detected”, the processor 210 determines that the malfunction is caused and causes the breaker circuit to interrupt distribution of electric power. There is no possibility that the heater element 100 is abnormally overheated more by causing the breaker circuit to interrupt distribution of electric power.

Therefore, the control system 1000 makes it possible to “suppress overheating of the heater element 100 without providing the heater element 100 with the overheat prevention device”.

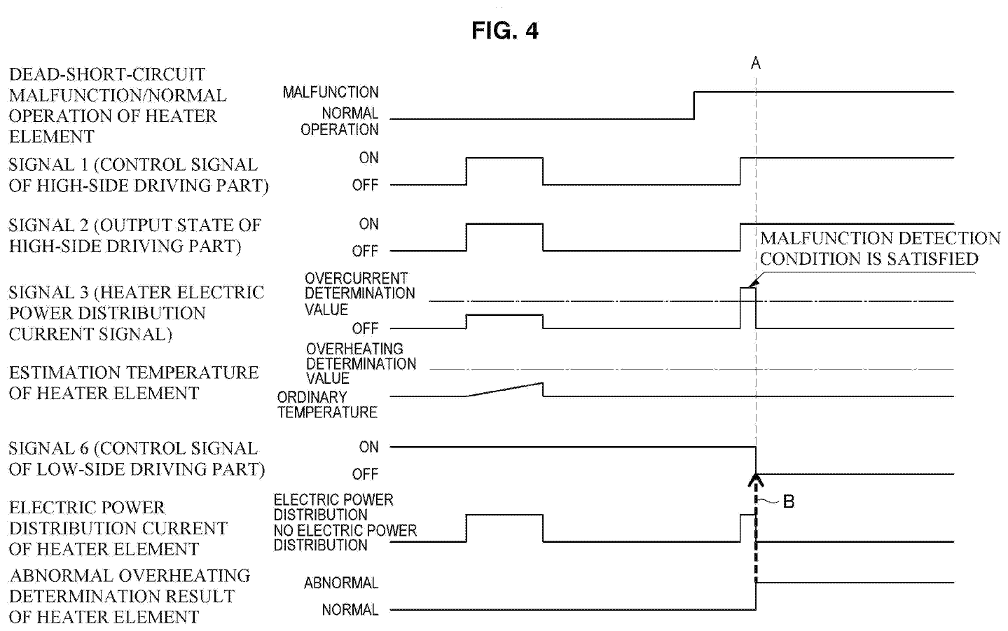

FIG. 4 is an explanatory diagram for describing an example in which the control device 200 according to the embodiment of the present invention determines that the heater element 100 malfunctions.

Here, “estimation temperature of the heater element 100” is an estimation value of temperature of the heater element 100. For example, it is possible to calculate the “estimation temperature of the heater element 100” by using supply periods in which the electric power control circuit outputs voltage, current, electric power to the heater element 100, a heat generation coefficient of the heater element 100, and a heat release coefficient of the heater element 100. Note that, the estimation temperature of the heater element 100 may be calculated through any algorithm capable of estimating temperature of the heater element 100, and the estimation method is not specifically limited. For example, the process of estimating temperature of the heater element 100 may be performed by the processor 210 or the electric power control circuit. In addition, it is also possible for the processor 210 to determine whether malfunction is caused on the basis of the estimation temperature of the heater element 100 calculated by the external device of the control device 200. The same applies hereinafter with regard to the other drawings.

For example, as indicated by A in FIG. 4, the processor 210 determines that the heater element 100 malfunctions “in the case where a current value indicated by the signal 3 is higher than the overcurrent determination value while the signal 1 indicating ON (first control signal) is being transmitted to the electric power control circuit and the signal 2 indicating ON is detected” (or “in the case where a current value indicated by the signal 3 is the overcurrent determination value or higher while the signal 1 indicating ON is being transmitted to the electric power control circuit and the signal 2 indicating ON is detected”. The same applies hereinafter). “The case where the current value indicated by the signal 3 is higher than the overcurrent determination value while the signal 1 indicating ON is being transmitted to the electric power control circuit and the signal 2 indicating ON is detected” corresponds to another example in which “the electric power control circuit is in the operating state and abnormal overheating of the heater element 100 is detected”. For example, malfunction in the heater element 100 determined in the example illustrated in FIG. 4 corresponds to malfunction called dead-short-circuit malfunction among malfunctions in the heater element 100.

Next, as indicated by B in FIG. 4, the processor 210 causes the breaker circuit to interrupt distribution of electric power by transmitting the signal 6 indicating OFF (second control signal) to the low-side driving part 206.

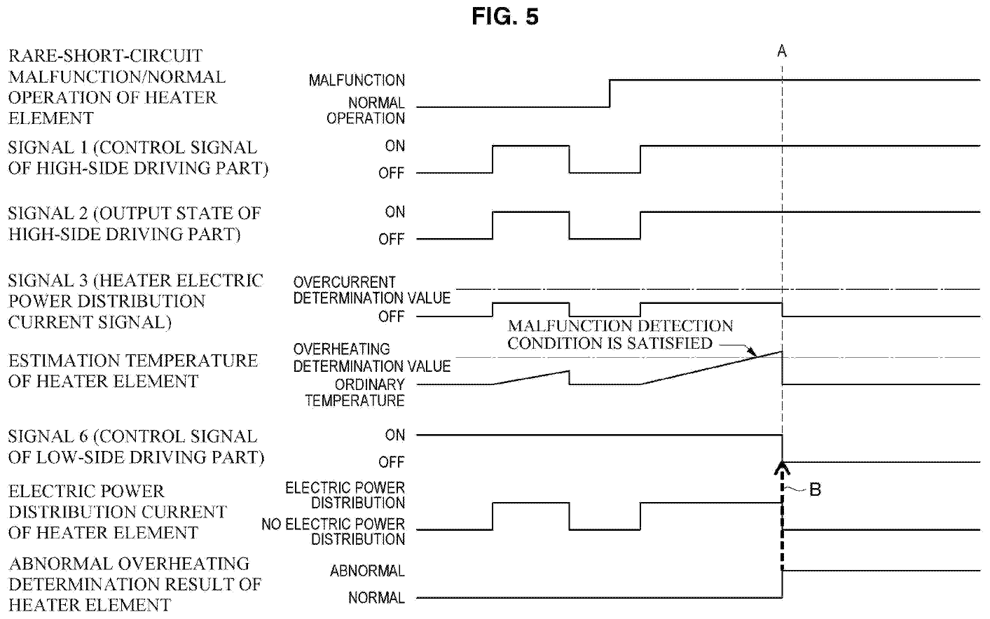

FIG. 5 is an explanatory diagram for describing another example in which the control device 200 according to the embodiment of the present invention determines that the heater element 100 malfunctions.

For example, as indicated by A in FIG. 4, the processor 210 determines that the heater element 100 malfunctions “in the case where estimation temperature of the heater element 100 is higher than the overheating determination value while the signal 1 indicating ON (first control signal) is being transmitted to the electric power control circuit and the signal 2 indicating ON is detected” (or “in the case where the estimation temperature of the heater element 100 is the overheating determination value or higher while the signal 1 indicating ON (first control signal) is being transmitted to the electric power control circuit and the signal 2 indicating ON is detected”. The same applies hereinafter). For example, the overheating determination value may be a fixed value that has been set in advance, or may be a variable value that can be changed by operation performed by the user of the control system 1000 or the like. “The case where the estimation temperature of the heater element 100 is higher than the overheating determination value while the signal 1 indicating ON is being transmitted to the electric power control circuit and the signal 2 indicating ON is detected” corresponds to an example in which “the electric power control circuit is in the operating state and abnormal overheating of the heater element 100 is detected”. For example, malfunction in the heater element 100 determined in the example illustrated in FIG. 5 corresponds to malfunction called rare-short-circuit malfunction among the malfunctions in the heater element 100.

Next, as indicated by B in FIG. 5, the processor 210 causes the breaker circuit to interrupt distribution of electric power by transmitting the signal 6 indicating OFF (second control signal) to the low-side driving part 206.

For example, as indicated by A in FIG. 4 and A in FIG. 5, the processor 210 determines that the heater element 100 malfunctions and causes the breaker circuit to interrupt distribution of electric power.

Note that, the process performed in the case where it is determined that the heater element 100 malfunctions is not limited to the above-described examples. For example, in a way similar to the malfunction determination according to the first example described in (1), it is also possible for the processor 210 to cause the breaker circuit to automatically cancel the interruption of the distribution of electric power after causing the breaker circuit to interrupt the distribution of electric power.

After the breaker circuit automatically cancels interruption of distribution of electric power, the processor 210 again determines whether malfunction is caused in accordance with the second example, and causes the breaker circuit to interrupt distribution of electric power in accordance with a result of the determination. Therefore, the control system 1000 makes it possible to “suppress overheating of the heater element 100 without providing the heater element 100 with the overheat prevention device” even in the case where the breaker circuit automatically cancel interruption of distribution of electric power.

(3) Third Example of Malfunction Determination: Abnormality in Characteristics of Temperature Detection Element 300

The processor 210 determines that the temperature detection element 300 malfunctions “in the case where abnormality in the temperature detection element 300 is detected on the basis of ambient temperature of the heater element 100 and detection temperature detected via the temperature detection element 300” (an example in which the malfunction detection condition is satisfied).

For example, the ambient temperature of the heater element 100 is measured by “a temperature sensor installed near the heater element 100 independently from the temperature detection element 300”. The type of the temperature sensor is not specifically limited. The processor 210 acquires data indicating the temperature measured by the temperature sensor from the external device of the control device 200, and uses the temperature indicated by the acquired data as the ambient temperature for determining malfunction.

Here, in the case where detection temperature is drastically different from the ambient temperature, there is a possibility that the temperature detection element 300 malfunctions. In the case where the temperature detection element 300 malfunctions, it is impossible to normally measure temperature of the heater element 100. This increases a possibility that temperature of the heater element 100 exceeds the specified temperature, that is, a possibility that abnormal overheating of the heater element 100 is caused.

Therefore, “in the case where abnormality in the temperature detection element 300 is detected on the basis of the ambient temperature of the heater element 100 and detection temperature detected via the temperature detection element 300”, the processor 210 determines that malfunction is caused, and cause the breaker circuit to interrupt distribution of electric power. There is no possibility that the abnormal overheating of the heater element 100 is caused by causing the breaker circuit to interrupt distribution of electric power even in the case where the temperature detection element 300 malfunctions.

Therefore, the control system 1000 makes it possible to “suppress overheating of the heater element 100 without providing the heater element 100 with the overheat prevention device”.

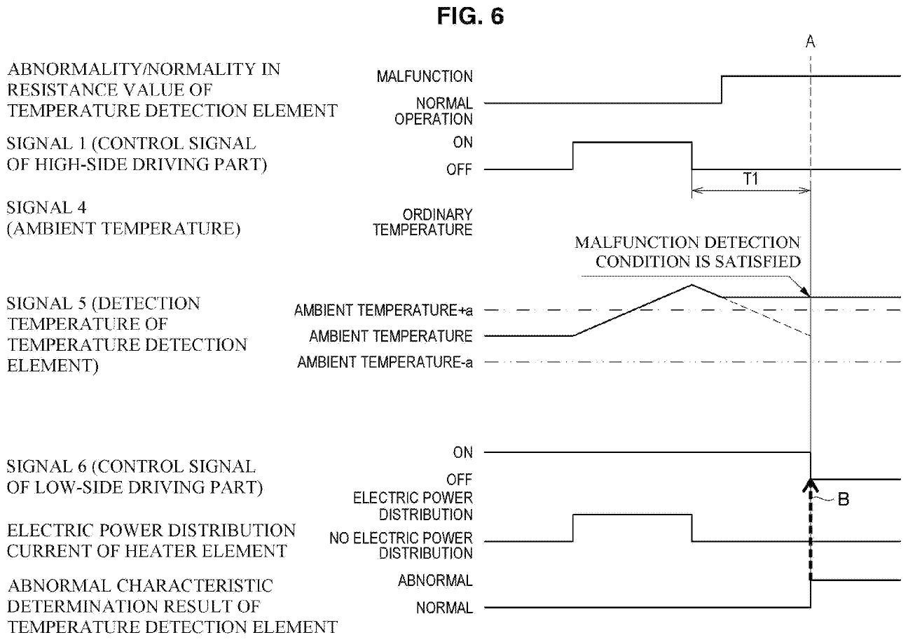

FIG. 6 is an explanatory diagram for describing an example in which the control device 200 according to the embodiment of the present invention determines that the temperature detection element 300 malfunctions.

Here, the “signal 4” is a signal indicating the ambient temperature. FIG. 6 illustrates an example in which the ambient temperature is “ordinary temperature”. The case where the ambient temperature is the ordinary temperature means that “the ambient temperature falls within a normal temperature range that is assumed during a design phase. The “signal 5” is a signal indicating the detection temperature. FIG. 6 illustrates the detection temperature as temperature relative to the ambient temperature. The same applies hereinafter with regard to the other drawings.

“Ambient temperature+a” illustrated in FIG. 6 (a is a “constant set during the design phase or the like”, for example) is a first determination threshold corresponding to the ambient temperature (third abnormality determination threshold). In addition, “ambient temperature−a” illustrated in FIG. 6 is a second determination threshold corresponding to the ambient temperature (second abnormality determination threshold). Note that, the examples of the first determination threshold and the second determination threshold corresponding to the ambient temperature are not limited to the examples illustrated in FIG. 6. For example, each of the first determination threshold and the second determination threshold may be a fixed value that has been set in advance, or may be a variable value that can be changed by operation performed by the user of the control system 1000 or the like. The same applies hereinafter with regard to the other drawings.

“T1” illustrated in FIG. 6 is a “time period taken to change temperature of the temperature detection element 300 to the ambient temperature” (for example, the time period expressed in units of [seconds]) when the electric power control circuit is shifted from the operating state to the non-operating state. Examples of the time period T1 include a fixed time period that has been set during the design phase or the like. Note that, the time period T1 may be a variable period of time that can be changed by operation performed by the user of the control system 1000 or the like. The same applies hereinafter with regard to the other drawings.

As indicated by A in FIG. 6, the processor 210 determines that the temperature detection element 300 malfunctions “in the case where the detection temperature is higher than the first determination threshold corresponding to the ambient temperature when the predetermined time period T1 elapses after the electric power control circuit is shifted from the operating state to the non-operating state” (or “in the case where the detection temperature is the first determination threshold or higher when the predetermined time period T1 elapses.” The same applies hereinafter). “The case where the detection temperature is higher than the first determination threshold corresponding to the ambient temperature when the predetermined time period T1 elapses after the electric power control circuit is shifted from the operating state to the non-operating state” corresponds to an example in which “abnormality in the temperature detection element 300 is detected on the basis of the ambient temperature of the heater element 100 and the detection temperature detected via the temperature detection element 300”.

Next, as indicated by B in FIG. 6, the processor 210 causes the breaker circuit to interrupt distribution of electric power by transmitting the signal 6 indicating OFF (second control signal) to the low-side driving part 206.

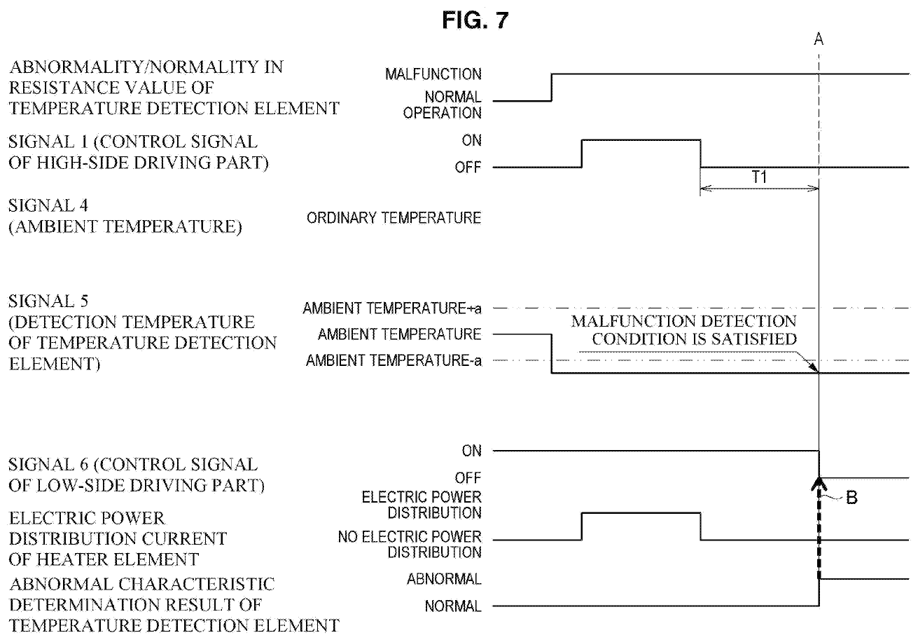

FIG. 7 is an explanatory diagram for describing another example in which the control device 200 according to the embodiment of the present invention determines that the temperature detection element 300 malfunctions.

As indicated by A in FIG. 7, the processor 210 determines that the temperature detection element 300 malfunctions “in the case where the detection temperature is lower than the second determination threshold corresponding to the ambient temperature when the predetermined time period T1 elapses after the electric power control circuit is shifted from the operating state to the non-operating state” (or “in the case where the detection temperature is the second determination threshold or lower when the predetermined time period T1 elapses.” The same applies hereinafter). “The case where the detection temperature is lower than the second determination threshold corresponding to the ambient temperature when the predetermined time period T1 elapses after the electric power control circuit is shifted from the operating state to the non-operating state” corresponds to another example in which “abnormality in the temperature detection element 300 is detected on the basis of the ambient temperature of the heater element 100 and the detection temperature detected via the temperature detection element 300”.

Next, as indicated by B in FIG. 7, the processor 210 causes the breaker circuit to interrupt distribution of electric power by transmitting the signal 6 indicating OFF (second control signal) to the low-side driving part 206.

Note that, the process performed in the case where it is determined that the heater element 300 malfunctions is not limited to the above-described examples. For example, it is also possible for the processor 210 to cause the breaker circuit to automatically cancel the interruption of the distribution of electric power after causing the breaker circuit to interrupt the distribution of electric power.

For example, the processor 210 causes the breaker circuit to cancel the interruption of the distribution of the electric power “when abnormality in the temperature detection element is not detected after causing the breaker circuit to interrupt the distribution of the electric power”. For example, as described with reference to FIG. 6 and FIG. 7, the abnormality in the temperature detection element 300 is detected by comparing the detection temperature with each of the first determination threshold and the second determination threshold. The processor 210 causes the breaker circuit to cancel interruption of distribution of electric power by transmitting the signal 6 indicating ON (second control signal) to the low-side driving part 206.

After the breaker circuit automatically cancels interruption of distribution of electric power, the processor 210 again determines whether malfunction is caused in accordance with the third example, and causes the breaker circuit to interrupt distribution of electric power in accordance with a result of the determination. Therefore, the control system 1000 makes it possible to “suppress overheating of the heater element 100 without providing the heater element 100 with the overheat prevention device” even in the case where the breaker circuit automatically cancel interruption of distribution of electric power.

(4) Fourth Example of Malfunction Determination

The processor 210 may determine whether malfunction is caused with regard to driving of the heater element 100 by making two or more types of malfunction determinations among the malfunction determination according to the first example described in (1) to the malfunction determination according to the third example described in (3). The processor 210 determines that malfunction is caused with regard to driving of the heater element 100 in the case where it is determined that the malfunction is caused through any of the above-described malfunction determinations, for example.

For example, the control device 200 adopts the configuration illustrated in FIG. 1 to control over driving of the heater element 100 and suppress overheating of the heater element 100.

Note that, the configuration of the control unit 200 is not limited to the example illustrated in FIG. 1.

For example, the control device 200 does not have to include the output state detection circuit 204. Even if the control device 200 does not include the output state detection circuit 204, the control device 200 is capable of suppressing overheating of the heater element 100 by determining whether malfunction is caused with regard to driving of the heater element 100 through any of the malfunction determination according to the first example described in (1) to the malfunction determination according to the third example described in (3). Note that, the output state detection circuit 204 may be an external circuit of the control device 200.

In addition, for example, the control device 200 does not have to include the temperature detection circuit 208. Even if the control device 200 does not include the temperature detection circuit 208, the control device 200 is capable of suppressing overheating of the heater element 100 by determining whether malfunction is caused with regard to driving of the heater element 100 through the malfunction determination according to the first example described in (1) or the malfunction determination according to the second example described in (2). Note that, the temperature detection circuit 208 may be an external circuit of the control device 200.

[3] Example of Effect Achieved by Control System According to Embodiment of Present Invention

For example, the following effects are achieved when using the control system according to the embodiment of the present invention. Of course, however, the effects achieved by the control system according to the embodiment of the present invention are not limited to the following effects.
It is not necessary to provide the heater element with the overheat prevention device because the control device detects that malfunction is caused with regard to driving of the heater element and interrupts distribution of electric power to the heater element. This makes it possible to reduce system most by using the control system according to the embodiment of the present invention.

[4] Application Example of Control System According to Embodiment of Present Invention

The control system according to the embodiment of the present invention has been described above. However, it is also possible to apply the control system according to the embodiment of the present invention to various kinds of system that can be provided with the heater element such as a “system installed in any vehicle like a car, an airplane, a ship, or a train, for example.

In the case where the control system according to the embodiment of the present invention is applied to the car, the heater element is installed in a steering wheel or a seat of the car. In the case where the control system is applied to the car, examples of the con device include an integrated circuit for controlling the heater element. In addition, the control device may be a computer such as an integrated electronic control unit (ECU), a body system ECU, or an information system ECU. In addition, the functions of the control device may be implemented by a plurality of ECUs included in the car, for example.

Hereinabove, although the preferred embodiments of the present invention has been described with reference to the accompanying drawings, it goes without saying that the present invention is not limited thereto. It will be clear to a person of ordinary skill in the art of the present invention that various modifications and improvements may be obtained within the scope of the technological concept recited by the scope of the patent claims, and these should obviously be understood as belonging to the range of technology of the present invention.

### REFERENCE SIGNS LIST

100 heater element
200 control device
202 high-side driving part
204 output state detection circuit
206 low-side driving part
208 temperature detection circuit
210 processor
300 temperature detection element
1000 control system

1. A control device for controlling driving of a heater element that produces heat when electric power is supplied, the control device comprising:
an electric power control circuit configured to control electric power to be supplied to the heater element;
a breaker circuit configured to interrupt distribution of electric power to the heater element; and
a processor configured to control operation of the electric power control circuit and operation of the breaker circuit,
wherein the processor
determines whether malfunction is caused with regard to the driving of the heater element on a basis of a predetermined malfunction detection condition, and
causes the breaker circuit to interrupt the distribution of the electric power in a case where it is determined that the malfunction is caused.

2. The control device according to claim 1,
wherein, when the electric power control circuit is in a non-operating state, the processor determines that the malfunction is caused in a case of detecting operation of the electric power control circuit to supply electric power to the heater element.

3. The control device according to claim 1,
wherein, when the electric power control circuit is in an operating state, the processor determines that the malfunction is caused in a case of detecting abnormal overheating of the heater element.

4. The control device according to claim 3,
wherein the processor determines that the malfunction is caused
in a case where an estimation value of temperature of the heater element is larger than a first abnormality determination threshold when supply of electric power from the electric power control circuit to the heater element is detected while the electric power control circuit is in the operating state, or
in a case where the estimation value is the first abnormality determination threshold or more when the supply of electric power from the electric power control circuit to the heater element is detected while the electric power control circuit is in the operating state.

5. The control device according to claim 1, wherein
the processor puts the electric power control circuit into a non-operating state in the case where it is determined that the malfunction is caused, and
the processor causes the breaker circuit to cancel the interruption of the distribution of the electric power when the electric power control circuit is shifted from the non-operating state to an operating state after the breaker circuit interrupts the distribution of the electric power.

6. The control device according to claim 1, wherein
the heater element includes a temperature detection element for detecting temperature, and
the processor determines that the malfunction is caused in a case where abnormality in the temperature detection element is detected on a basis of ambient temperature of the heater element and detection temperature detected via the temperature detection element.

7. The control device according to claim 6,
wherein the processor determines that the malfunction is caused
in a case where the detection temperature is lower than a second abnormality determination threshold corresponding to the ambient temperature when a predetermined period of time elapses after the electric power control circuit is shifted from the operating state to the non-operating state, or
in a case where the detection temperature is the second abnormality determination threshold or less when the predetermined period of time elapses.

8. The control device according to claim 6,
wherein the processor causes the breaker circuit to cancel the interruption of the distribution of the electric power when abnormality in the temperature detection element is not detected after causing the breaker circuit to interrupt the distribution of the electric power.

9. A control system comprising:
a heater element configured to produces heat when electric power is supplied; and
a control device configured to control driving of the heater element,
wherein the control device includes
an electric power control circuit configured to control electric power to be supplied to the heater element,
a breaker circuit configured to interrupt distribution of electric power to the heater element, and
a processor configured to control operation of the electric power control circuit and operation of the breaker circuit, and
the processor
determines whether malfunction is caused with regard to the driving of the heater element on a basis of a predetermined malfunction detection condition, and
causes the breaker circuit to interrupt the distribution of the electric power in a case where it is determined that the malfunction is caused.

10. The control device according to claim 7,
wherein the processor causes the breaker circuit to cancel the interruption of the distribution of the electric power when abnormality in the temperature detection element is not detected after causing the breaker circuit to interrupt the distribution of the electric power.
